(19) United States
(12) Patent Application Publication
(10) Pub. No.: US 2015/0107122 A1
(43) Pub. Date: Apr. 23, 2015

(54) Multi-material ripping snips

(71) Applicant: Kristopher Joseph Mueller, Asheville, NC (US)

(72) Inventor: Kristopher Joseph Mueller, Asheville, NC (US)

(21) Appl. No.: 12/804,221

(22) Filed: Jul. 16, 2010

Related U.S. Application Data
(60) Provisional application No. 61/271,098, filed on Jul. 17, 2009.

(51) Int. Cl. B26D 1/15; B26B 13/06; B26B 13/22

(52) U.S. Cl. CPC B26B 13/06; B26B 13/22
USPC 30/388

(57) ABSTRACT

Snips and scissors that have traditional cutting blades in conjunction with cutter wheels attached and used for cutting sheet materials to be faster and more efficient than conventional snips and scissors, a tool with no conventional scissor blades but uses arms to attach the cutter wheels still using the scissors action to cut and also make gliding cuts in sheet materials with a safety cutter wheel assembly and embodied in children's type safety scissors, a tool that allows interchangeable wheels to be replaced for a new set or removable for sharpening of either the blade or the cutter wheels also a set of plinking

### PRIORITY CLAIM

Applicant hereby claims priority to U.S. Provisional Patent Application 61/271,098, entitled “Multi-Material Ripping Snips” filed on Jul. 17, 2009, to the fullest extent permitted under the law.

### BACKGROUND OF THE INVENTION

1. Field of invention

First and foremost new technology unique to concept the cutter wheels incorporated onto a body, blades or arms are not of a fixed position in relation to one another as shown in all other prior art. The cutter wheels are in a set position to where they are attached to a blade or an arm but are moveably operable independently of each other in a cutter wheel assembly set of two wheels. The cutter wheels are then moveably operable on offset vertical planes using a hinge or fulcrum point for pressure and an exact stop point position to create a cutter wheel assembly that cuts sheet materials. This invention relates to a hand held multi material cutting snips. This utility design incorporates cutter wheels into the tin snips and scissors design. This allows the user while cutting sheet goods to start the cut with the cutter blades using a scissors action and when a stop point is reached in the open position of the snips the user is able to rip cut and glide through long sections of the materials using the cutter wheels. The snips with the cutter wheels are able to cut all types of sheet goods from linoleum flooring, card stock, paper, carpet, sheet metal, vinyl siding and any type of sheet goods. There is also an industrial application present with this new technology by incorporating moveably operable cutter wheels in an industrial assembly line/machine technology application (paper mills, sheet plastics, sheet metal companies) This is a unique design in its multiple applications to help efficiency and productivity in industry, on the job, in the field and in home and hobby.

### POTENTIAL PRIOR ART

The below are for reference only, and nothing herein shall be construed as an admission that the below is considered prior art or relevant.

Patent U.S. Pat. No. 3,380,158

This patent is of a fixed cutter wheel assembly. It does attach wheels to separate leg portions but the legs are not moveably operable independent of each other.

Patent U.S. Pat. No. 3,815,231

This patent is of a fixed cutter wheel assembly but has a means of energizing (claim 1) the cutter wheels through a gear system however cutter wheels are not moveably operable independent of each other on a vertical plane.

This patent has a system where one cutter wheel can be adjustable changing the axis of the wheel in a horizontal left to right movement (claims 2, 3) but again the cutter wheels are not moveably operable independent of each other on a vertical plane.

This patent has a pair handles (claims 7, 8,9) however one is fixed to a body separate of the other that is attached to a gear system (claim 2) to engage the cutter wheel to pull the material inward using a typical scissor action. Unique but extremely different in function to the new technology using the handles in separate and in conjunction combined with moveably operable cutter wheel assembly to cut materials.

Patent U.S. Pat. No. 4,381,605

This patent is of a fixed cutter wheel assembly (claim 1). Non-moveable.

Patent U.S. Pat. No. 4,574,480

This patent is of a fixed cutter wheel assembly/body (claim 1) Non moveable.

The handle is of a singular tubular type that is changeable for lengths (claims all)

Patent U.S. Pat. No. 5,899,000

This patent is of a fixed cutter wheel assembly. Non-moveable

### GENERAL SUMMARY DISCUSSION OF INVENTION

The Primary objective is to invent the first ever moveably operable cutter wheel assembly hand tool.

The primary objective of the multi material ripping snips is to create a tool that uses the tin snip and scissors design and incorporates moveably operable cutting wheels in a unique efficient design.

A primary objective of this invention is to provide snips and scissors that have traditional cutting blades in conjunction with cutter wheels used for cutting sheet materials to be faster and more efficient than conventional snips and scissors.

An additional objective is to provide a utility design that is able to cut carpet, linoleum, sheet metal, card stock, paper and vinyl siding in a smooth gliding action.

An additional objective is to create a sleek, safe, intuitive tool that spans multiple materials in the tools function.

An additional objective is to create a tool with no conventional scissor blades but uses arms to attach the cutter wheels to still using the scissors action to cut and also make gliding cuts in sheet materials. With this in mind the invention would be of a safety cutter wheel assembly and embodied in children's type safety scissors.

A further objective is to create a tool that allows interchangeable wheels to be replaced for a new set or removable for sharpening of either the blade or the cutter wheels

A further objective is to create a tool that allows interchangeable wheels to be replaced with a set of plinking wheels of many different shapes and designs primarily used in paper crafts and scrap booking but not limited to paper or crafts and could be used on all sheet materials.

### BRIEF DESCRIPTION OF DRAWINGS

FIG. 1 Side view of said snips in open position

FIG. 2 Top view of said snips

FIG. 3 Side view of safety cutter wheel assembly

FIG. 4 Side view of said snips in closed position

### DETAILED DESCRIPTION OF PREFERRED EMBODIMENTS

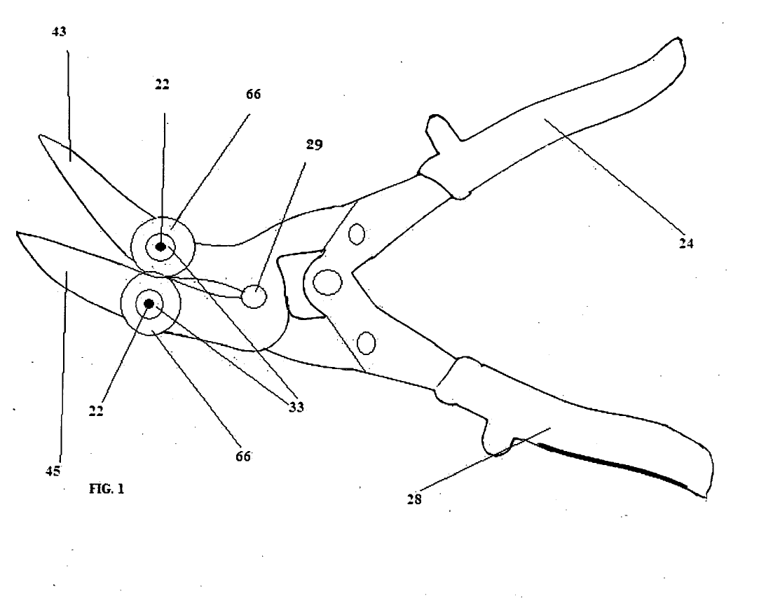

FIG. 1 tin snips with top snip handle 24 opposite bottom snip handle 28 used with the hand to manually operate as the handles are opposite the top snip blade 43 and opposite the bottom snip blade 45 incorporating cutter wheels 66 attached to bearing sets 33 fastened to the snip blades 43 and 45 using cutter wheel fastening nut and bolt assembly 22. all using the fulcrum hinge 29 to operate scissors action.

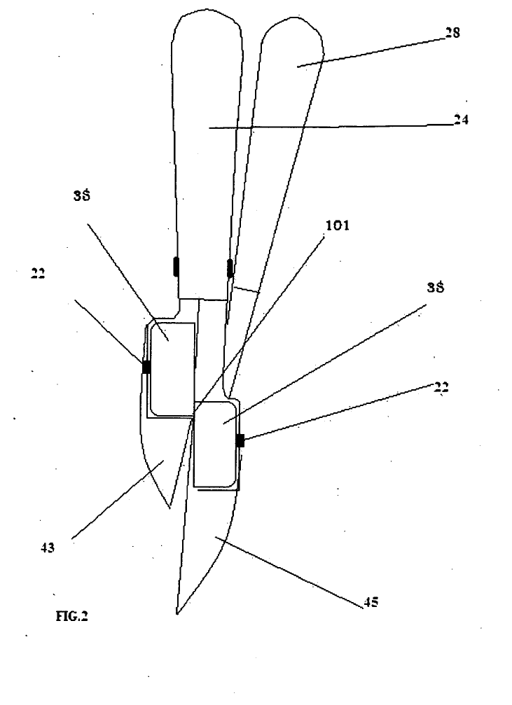

FIG. 2 tin snips with top snip handle 24 opposite bottom snips handle 28 used with the hand to manually operate as the handles are opposite top snip blade 43 opposite bottom snip blade 45 incorporating cutter wheel assembly 38 fastened to the snip blades 43 and 45 using cutter wheel fastening bolts 22 illustrating the optimal stop point position 101 in which the cutter wheel assembly receives sheet materials and will glide through the cut in the optimal stop point position 101.

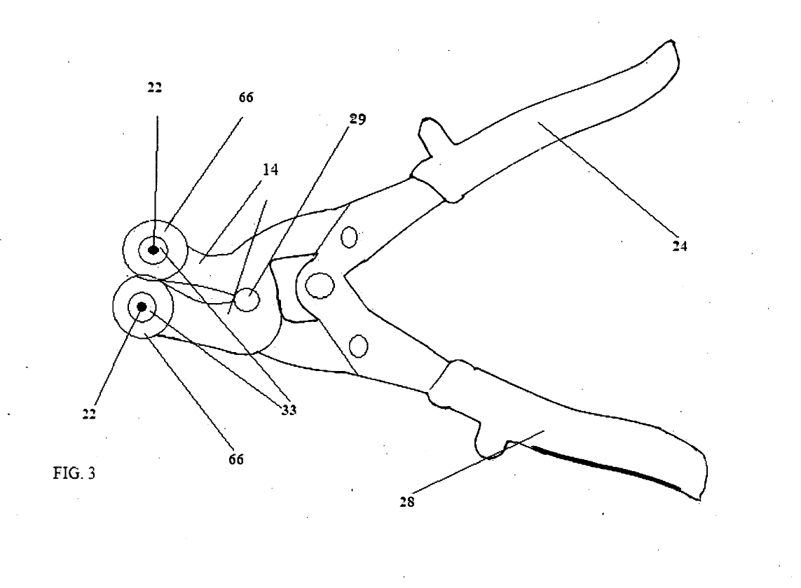

FIG. 3 Safety cutter assembly with top handle 24 opposite bottom handle 28 used with the hand to manually operate as the handles are opposite the cutter wheels 66 attached to bearing sets 33 fastened to the attachment arms 14 with cutter wheel fastening nut and bolt assembly 22 all using the fulcrum hinge 29 to operate scissors action.

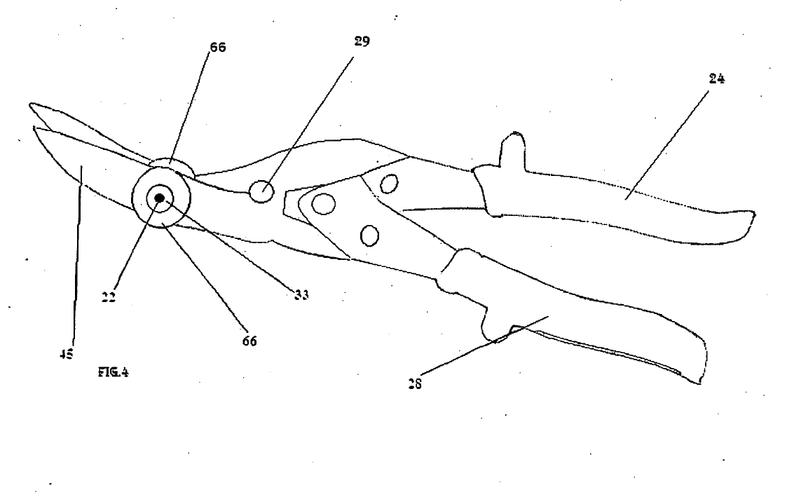

FIG. 4 tin snips with top snip handle 24 in closed position opposite bottom snip handle 28 used with the hand to manually operate as the handles are opposite the top snip blade 43 and opposite the bottom snip blade 45 incorporating cutter wheels 66 attached to bearing sets 33 fastened to the snip blades 43 and 45 using cutter wheel fastening nut and bolt assembly 22. all using the fulcrum hinge 29 to operate scissors action.

This invention relates to snips and scissors using cutter wheels in conjunction with snip blades that provides a unique and superior design to all prior art. I could not find the tool needed to do the desired task of using snip blades to conventionally cut sheet material along with a cutter wheel assembly to give me a gliding smooth cut where I could cut long runs very rapidly and if needed create a smooth curve in the materials I was cutting. So have discovered a severe need of a more superior tool able to cut multiple sheet materials. The tools I found are good in the trade specific applications of the tool but did not serve the need of the conventional blade cutting, cutter wheel glide and a smooth curve glide in one tool. In Patent and market research there is no tool of this unique utility design. Foremost new technology unique to concept is this technology for the first time allows the user to cut materials using the scissors/snipping action as in standard snips and scissors to get a cut started or for detailed work then proceed into a gliding cut action using the cutter wheel assembly. Then when needed the user is able to stop on a specific mark and can go back to the scissor/snipping action to then turn at any angle needed using the snipping/scissor action such as to make a right angle then continue into a glide cut with cutter wheel assembly thus allowing user to continue as many cuts needed to create all types of cuts, curves, infinite angles and shapes. Cutter wheels are movably operable separate from each other allowing for a cutter wheel assembly attachment to scissors, shears, snips, arms, bodies, and members. Allowing for the user to use the full function of the blade members to cut materials with the cutter wheels in the same plane as the blade members creating moveably operable cutter wheel assembly that does not hinder any function of the standard blade member's ability to cut materials

With respect to the above description then, it is realized that the optimum dimensional relationships for the parts of the invention, to include variation in size, material, shape, form, function and manner of usage, assembly and use are deemed readily apparent and obvious to one skilled in the art.

Therefore, the fore going description of the embodiments of the invention it will be apparent that many modifications may be made therein. It will be understood however that these embodiments of the invention are exemplifications of the invention only and that the invention is not limited thereto.

What is claimed:

1. A cutter wheel assembly comprising
cutter wheels attached to fixed points on blades that are movably operable along parallel vertical planes;

2. A cutter wheel assembly comprising
cutter wheels attached to fixed points on blades, bodies or arms that are movably operable separate from the other along parallel vertical planes;

3. A cutter wheel assembly comprising
cutter wheels attached to fixed points on blades, bodies or arms that are movably operable separate from each other along parallel vertical planes; having a stop point where the cutter wheel assembly when open is at an optimal point of intersection to cut sheet materials.

4-7. (canceled)
